(19) United States
(12) Patent Application Publication
(10) Pub. No.: US 2026/0336695 A1
(43) Pub. Date: Oct. 29, 2026

(54) Method and Device for Estimating a Steering Torque in a Steering System of a Vehicle

(71) Applicant: Robert Bosch GmbH, Stuttgart (DE)

(72) Inventors: Peter Reis, Farmington Hills, MI (US); Philipp Scheffler, Heilbronn (DE)

(21) Appl. No.: 19/486,928

(22) PCT Filed: May 7, 2024
(86) PCT No.: PCT/EP2024/062547

§ 371 Date: Nov. 22, 2025

(30) Foreign Application Priority Data
May 24, 2023 (DE) 10 2023 204 810.8

(51) Int. Cl. B62D 15/02; B62D 1/04; B62D 1/12; G06N 20/00

(52) U.S. Cl. CPC B62D 15/02; B62D 1/04; B62D 1/12; G06N 20/00

(57) ABSTRACT

A computer-implemented method and a device for estimating a steering torque in a steering system of a vehicle and/or machine is disclosed. The method includes (i) providing a machine-learning algorithm, (ii) providing at least one input signal comprising information about at least one movement variable of the electric motor of a control element of the steering system, and (iii) estimating, with the machine-learning algorithm, the steering torque applied by an operator via the control element based on the at least one input signal provided.

The invention relates to a method for estimating a steering torque in a steering system of a vehicle. Furthermore, the invention relates to a device for estimating a steering torque in a steering system of a vehicle.

### PRIOR ART

Vehicle steering systems are an important component of modern vehicles that allow the driver to safely control the vehicle. Steering wheel and/or pedal controls are traditionally used for initiating steering movements or for vehicle control. In addition, vehicle control via joystick is an alternative method to traditional steering wheel and pedal control of vehicles. There are various types of joysticks that can be used to control vehicles, including one-handed and two-handed joysticks.

There are various types of steering systems, including mechanical, hydraulic, electrical and electro-hydraulic steering systems.

Mechanical steering systems are known, such as rack-and-pinion steering systems and/or ball orbit steering systems and/or auger steering systems. Hydraulic steering systems use hydraulic pressure to steer the wheels. Electrical steering systems, on the other hand, use an electric motor to assist and/or perform steering movements. Electro-hydraulic steering systems combine the advantages of both systems by combining a hydraulic pump with an electric motor.

In modern vehicles, the so-called steer-by-wire (SbW) steering system is also often preferred. This is a vehicle control system, in which a mechanical steering system is replaced by electronic and/or electro-mechanical systems. A steering wheel or other steering control element is not directly connected to the wheels via a steering spindle. Rather, the steering is controlled via sensors and/or steering actuators that convert a steering movement of the driver at the steering wheel into electronic signals and send them to a controller via at least one cable or wirelessly. The controller then controls the wheels via electric motors and/or other drive systems. Steer-by-wire systems enable greater precision and adaptability in steering and can help reduce the need for space in the vehicle.

In modern steering systems, a torsion rod sensor is often employed to measure a steering angle initiated by the driver and/or the operator via the steering control element. The torsion rod sensor is a mechanical component used to measure rotational movements and/or torques and/or forces. The torsion rod sensor typically consists of a metal bar or metal rod that is deformed by rotation. The deformation of the rod may be electronically and/or mechanically measured and provides information on the rotational movement and/or force acting on the rod.

A typical application example for torsion rod sensors are force measurements in motor vehicles. There, for example, they can be used to measure wheel loads, monitor axle loads, and/or measure steering forces. Torsion rod sensors are also used in other areas such as medical technology, robotics, and industrial technology.

Since the torsion rod sensor is an additional component that requires calibration and/or maintenance on one hand, and does not always output a correct measurement signal on the other hand, there are increasing attempts to also provide information on rotational movement and/or torque and/or force in an alternative or supplementary manner.

The invention thus solves the task of providing an improved and in particular hardware-optimized method as well as an improved and in particular hardware-optimized device.

The task is solved with a method for estimating a steering torque in a steering system of a vehicle according to the features of claim 1. Furthermore, the task is solved with a device for estimating a steering torque in a steering system of a vehicle according to the features of claim 10.

### DISCLOSURE OF THE INVENTION

In a first aspect, a computer-implemented method for estimating a steering torque in a steering system of a vehicle and/or a machine is provided. The method comprises the steps of: providing a machine-learning algorithm; providing at least one input signal comprising information about at least one movement variable of an electric motor of a control element of the steering system; and estimating steering torque applied by an operator by means of the control element by using the machine-learning algorithm based on the provided input signal.

It is understood that the steps according to the invention and further optional steps do not necessarily have to be carried out in the order shown, but may also be carried out in a different order. Furthermore, intermediate steps may also be provided. The individual steps may also comprise one or more sub-steps without going beyond the scope of the method according to the invention.

In a second aspect, a device for estimating a steering torque in a steering system of a vehicle and/or a machine is provided. The device comprises a provisioning device, which is configured to provide a machine-learning algorithm and at least one input signal, which comprises information about at least one movement variable of an electric motor of a control element of the steering system; and an analysis and computation device, which is configured to estimate and/or approximate the steering torque applied by an operator by means of the control element by using the machine-learning algorithm based on the provided input signal.

An advantage of the invention is that by estimating the steering torque, it is fundamentally possible to refrain from using a torsion rod sensor in the steering system in question. According to the present invention, it is possible to estimate the steering torque without necessarily having to measure the steering torque with a torsion rod sensor. This may achieve a cost reduction for a steering system configured in this way. The torsion rod sensor is also omitted as a component, so that more design space is available. The method according to the invention as well as the device according to the invention also have a positive effect on the costs of producing a steering system.

In principle, the torsion rod sensor can also be retained in the relevant steering system and be supplemented by estimating the steering torque according to the invention. This may be preferred, for example, for plausibility checks of measurement results of the torsion rod sensor and/or for increasing the measurement accuracy of the torsion rod sensor. In addition, with the additional and/or supplemental estimation of the steering torque, a dual-channel torsion rod sensor may be installed instead of a single-channel torsion rod sensor so that the cost of such a torsion rod sensor and the complexity of a torsion rod sensor analysis unit may be reduced.

The electric motor is preferably a steering wheel actuator (SWA). Stated another way, the electric motor is preferably a control actuator. The at least one input signal preferably comprises information about at least one movement variable of the electric motor of the control element, through which information is particularly provided about how the electric motor moves and/or behaves and/or in which current (actual) position a rotor of the electric motor is relative to a stator of the electric motor. The at least one input signal preferably comprises a plurality of input data about the electric motor. The input data is preferably movement data about the electric motor. The electric motor may also generally comprise a transmission, but preferably not a steering gear of the steering system.

According to the invention, a vehicle is understood to be a delivery truck and/or a passenger vehicle and/or a transport vehicle and/or a motor vehicle and/or a marine vehicle and/or an aircraft and/or a military vehicle and/or a crane and/or an excavator vehicle and/or a tractor and/or a caterpillar vehicle and/or a construction vehicle and/or a mobile hydraulic vehicle. Furthermore, the method and/or device according to the invention for estimating a steering torque in a steering system can particularly be employed in industrial machines and/or a tool. In other words, the method and/or device according to the invention can also be used in other, particularly non-vehicle applications, in which steering inputs are used for controlling a tool head or the like. For example, the method and/or device according to the invention may be advantageous in manual or semi-automatic control and/or steering of machines by an operator and/or by an automated function.

In particular, the method and/or device according to the invention is used in a steer-by-wire (SbW) steering system. In principle, the method and/or device according to the invention can also be used in other steering systems.

In one embodiment, the machine-learning algorithm comprises an explainable boosting machine, EBM, algorithm, and/or a generalized additive model, GAM, algorithm, and/or a regression-based algorithm. Generally, other machine-learning algorithms, such as neural networks and/or gradient-boosted tree algorithms and/or k-nearest neighbor algorithms and/or decision tree algorithms, are also applicable.

A regression-based algorithm is straightforward to understand, and in particular, is suitable for processing input signals and/or input data that are linearly related to each other. In particular, such a regression-based algorithm is configured to determine a relationship between the input signals and/or input data based on linear regression.

An explainable boosting machine (EBM) algorithm is preferably a machine-learning model configured to make predictions based on input data and/or input signals. EBM algorithms are part of the boosting algorithm family that build a stronger model by combining multiple weak learning models. Unlike many other machine-learning models, an EBM algorithm provides higher interpretability as it is based on a decision rule structure that allows the results of the predictions to be presented in human-readable form. This means that it is easier to understand how and why the model has reached a particular prediction. Another advantage of an EBM algorithm is that it is robust against outliers and missing data and is scalable when using categorical and/or numerical variables. Thus, it is often used in applications that require high interpretability and accuracy.

A Generalized Additive Model (GAM) algorithm is a statistical model used to model a non-linear relationship between a dependent variable and one or more independent variables. Unlike linear models that can only model a linear relationship between variables, GAMs allow the modeling of complex non-linear relationships. GAMs are based on the assumption that a non-linear relationship between the variables can be modeled by a combination of smooth functions. For example, smoothing functions can be splines and/or local regressions. The estimation of the smooth functions is performed using optimization algorithms that find the best combination of the smooth functions. One advantage of GAMs is that they are very interpretable as they may represent the relationship between the dependent and independent variable in a graphical form. This may be very helpful in interpreting the results.

In one embodiment, a fit function for a plurality of data points is determined by the GAM algorithm based on a plurality of cumulative spline functions, particularly using at least one regularization term. For example, these may be b-spline functions. The respective spline function preferably describes a respective shape function for a respective data point and/or for a respective input signal. The regularization term may preferably be used to approximate a data curve and/or signal curve of the at least one input signal and/or the input data. Non-linear data links between the input signals and/or input data may also be determined by a preferred GAM algorithm. Such a GAM algorithm is powerful and yet has a high level of comprehensibility compared to other machine-learning algorithms.

Such a GAM algorithm may be indicated, for example, by the formula:

g(E[y])=β₀+f₁(x₁)+f₂(x₂)+ . . . +fₘ(xₘ) {equation 1}
wherein g(E(Y) is the fitted input signal function, β₀ is a data offset to the at least one input signal, and fₘ(xₘ) is an mth spline function to an mth input signal.

In one embodiment, the EBM algorithm is built on a GAM algorithm and is augmented with a data tree-based approach. The EBM algorithm is thus a data tree-based approach, in which bootstrapping of the input signals and/or the input data as well as aggregation of the at least one input signal and the input data takes place. The EBM algorithm preferably comprises gradient boosting. The EBM algorithm is preferably trained through round robin training. Series of restricted data trees are preferably used as the basis. Furthermore, during the training, residuals are preferably calculated from a respective input signal average. Scaling of the EBM algorithm is done via the learning rate, which is considered to be very low.

Round robin training is a machine-learning method, in which multiple models are trained simultaneously by applying them sequentially to the same data set. In round robin training, multiple models are trained by applying them sequentially to the same training data set in a rotating cycle. That is to say, each model is trained once consecutively before it is the next model's turn. In this way, all models are trained evenly and a model is prevented from always seeing the same training data set and thereby being over-adapted. After each training session, the weights of the model are saved and the next model begins to exercise with those weights. This ensures that each model has a similar starting position and does not accidentally start with other weights. Round robin training can be particularly useful when it is difficult to find the best training approach for a particular problem or when training data is limited. By using multiple models, the risk of over-adapting can be reduced and overall performance of the models can be improved.

In one embodiment, the machine-learning algorithm is based on training data via the at least one input signal or movement data of the electric motor of the steering system control element. The training data preferably includes information about a plurality of movement data of the electric motor. For example, the movement data may be determined at least partially sensorially, for example via a position and/or location sensor of the electric motor, which determines a position of the rotor relative to the stator. The movement data may alternatively or supplementally also be provided by time differentiation of a sensorially recorded measurement signal. Training of the machine-learning algorithm is preferably performed separately and/or in parallel for each piece of information about the movement of the electric motor.

In one embodiment, the at least one input signal comprises rotor position information and/or rotor speed information and/or rotor acceleration information and/or rotor jerking information and/or motor target torque information and/or information about a gradient of the motor target torque and/or motor actual torque information and/or information about a gradient of the motor actual torque. Particularly preferably, the respective information is captured as time series so that a plurality of respective data points are available over a predetermined time that the machine-learning algorithm can evaluate. Based on the data points, the machine-learning algorithm is preferably also trained on a feature-specific basis.

In one embodiment, the at least one input signal is filtered, particularly by applying moving average and/or a low-pass filter. In principle, other signal filters and/or data filters are also conceivable in order to exclude, preferably in particular, outliers and/or erroneous data points from the data set from the outset.

In one embodiment, the control element comprises a steering wheel and/or joystick and/or steering lever and/or steering switch. The control element may vary depending on the type of vehicle and/or machine and/or steering technology. By way of example, the control element may include: a steering wheel that is probably the most commonly used steering control in vehicles, which typically includes a frame with handles that the driver grasps and rotates to steer the vehicle. It may preferably be (a) a steering wheel of a steer-by-wire steering system; (b) a joystick that is an alternative to the steering wheel used in some vehicles and/or steering systems. The joystick is similar to an aircraft control and may preferably allow for intuitive control; (c) a steering lever, as a steering control, used primarily in commercial vehicles and/or agricultural machines. The steering lever may be either laterally mounted or placed in the center of the operator cabin; and/or (d) a steering switch through which a vehicle and/or machine and/or a steering system is operable via at least one switch, for example, on a console and/or on a dashboard.

Furthermore, the invention relates to a controller of a steering system and/or a vehicle comprising at least one processor and/or an analysis and control device configured to at least partially perform the method according to the invention in any embodiment. The controller and/or the analysis and control device do not have to perform all steps of the method, but can perform only a part of the steps of the method. The controller may be configured as a smart control unit (SCU) of a steering system, also referred to as a steering SCU. The controller may be configured as a control unit of a steering wheel actuator (SWA) and/or a control element actuator. The controller may be a control unit of an electro-mechanical power steering system, also referred to as an EPS (Electric Power Steering) system. Alternatively, the controller may be included in, or configured by, a central controller and/or a central computer of an automobile and/or a machine.

Furthermore, the invention relates to a steering system of a vehicle and/or a machine comprising a control element for applying steering torque by an operator, an electric motor that is connected in such a way to transmit motion and/or torque; and a device and/or control unit according to the invention.

According to the invention, a computer program with program code is also claimed, which performs at least portions of the method according to the invention in one of its embodiments, when the computer program is executed on a computer. In other words, the computer program (product) according to the invention comprises commands that, when the program is executed by a computer, cause the computer to perform the steps of the method according to the invention in one of its embodiments.

According to the invention, a computer-readable data carrier with program code is also proposed, which performs at least portions of the method according to the invention in one of its embodiments, when the computer program is executed on a computer. In other words, the invention concerns a computer-readable memory medium comprising commands that, when the program is executed by a computer, cause the computer to perform the steps of the method according to the invention in one of its embodiments.

The described embodiments and further developments may be combined with one another as desired.

Further possible configurations, refinements, and implementations of the invention also comprise not explicitly mentioned combinations of features of the invention described above or below with respect to exemplary embodiments.

### BRIEF DESCRIPTION OF THE DRAWINGS

The accompanying drawings are intended to provide a better understanding of the embodiments of the invention. They illustrate embodiments and, in connection with the description, serve to explain principles and concepts of the invention.

Other embodiments and many of the mentioned advantages become apparent from the drawings. The illustrated elements of the drawings are not necessarily shown to scale with respect to one another.

The figures show:

FIG. 1 a schematic flow chart of a method according to the invention;

FIG. 2 a schematic flow chart of an example machine-learning algorithm;

FIG. 3A a schematic diagram comparing a measured steering torque and an estimated steering torque according to the invention; and

FIG. 3B a schematic diagram of a time course of a torque error of the steering torque estimated according to the invention.

In the figures of the drawings, identical reference numbers denote identical or functionally identical elements, parts or components, unless stated otherwise.

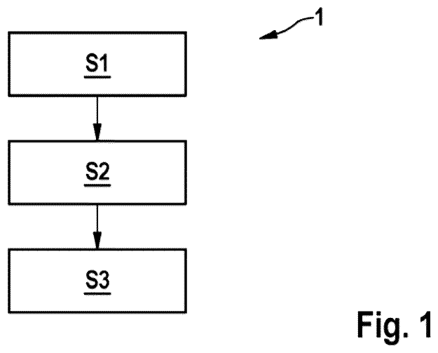

FIG. 1 shows a schematic block diagram of a computer-implemented method and device 1 for estimating a steering torque in a steering system of a vehicle and/or a machine.

In any embodiment, the method may be performed at least in part by the device 1, which may comprise a plurality of components not shown here, for example one or more supply devices and/or at least one analysis and calculation device. It is understood that the supply device may be configured together with the analysis and computing device or may be different from it. Furthermore, the system may comprise a storage device and/or an output device and/or a display device and/or an input device.

According to the invention, the computer-implemented method comprises at least the following steps:

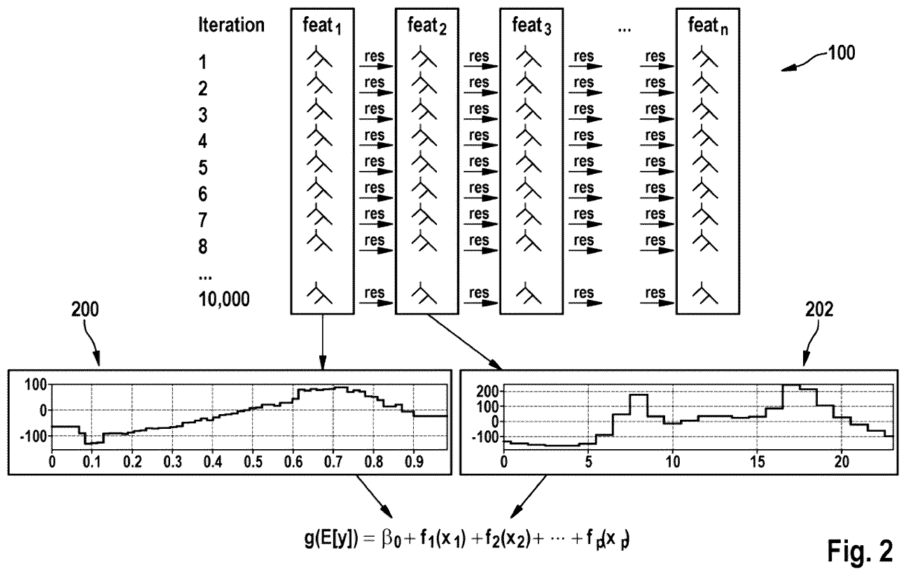

In a step S1, a machine-learning algorithm 100 is provided. For example, the machine-learning algorithm comprises an explainable boosting machine, EBM, algorithm as shown schematically in greatly simplified manner and incompletely indicated in FIG. 2. Alternatively, or in addition, the machine-learning algorithm comprises a generalized additive model, GAM, algorithm, and/or a regression-based algorithm.

In a step S2, at least one input signal is provided comprising information concerning at least one movement variable of the electric motor of a control element of the steering system. The at least one input signal comprises rotor position information feat₁ and/or rotor speed information feat₂ and/or rotor acceleration information feat₃ and/or rotor jerking information featₙ₋₄ and/or a motor target torque information featₙ₋₃ and/or information about a gradient of the motor target torque featₙ₋₂ and/or a motor actual torque information featₙ₋₁ and/or information about a gradient of the motor actual torque featₙ. The features featₙ₋₄ to featₙ₋₁ are not indicated in FIG. 2, but are merely indicated by three dots ( . . . ).

In a step S3, the steering torque applied by an operator via the control element is estimated by the particularly trained machine-learning algorithm based on the at least one input signal provided.

In FIG. 2, a training method of the machine-learning algorithm 100, in the present case an EBM algorithm, is shown schematically in a simplified manner. The training is preferably based on n-features, feat₁ to featₙ. In a first iteration step, a small, preferably non-complex, data tree is trained based on the first feature feat₁. This data tree may preferably only use feature feat₁. Boosting (enhancing) preferably updates a residual value (residual) of the data tree. Then, the procedure preferably continues in an equivalent manner to feature feat₂. In the first iteration step, a small, preferably non-complex data tree is then trained based on the second feature feat₂. This data tree may preferably only use feature feat₂. Boosting preferably updates a residual value (residual) of this data tree. In the same manner, the procedure preferably continues with the features feat₃ to featₙ. With this approach, a round robin path is generated by all features feat₁ to featₙ. Each of the generated data trees may preferably consider only a single feature. The learning rate of the method is so small that the order of the individual features feat₁ to featₙ preferably does not play a role. Rather, a plurality of such iteration steps, for example, up to 10000 iteration steps or more, are performed. As a result, preferably new data trees are generated per feature and per iteration step.

After completion of the iteration steps i, a number i of data trees were generated for each feature feat₁ to featₙ, which were each trained only on the basis of the respective feature. If these data trees are now summed up, a chart 200, 202 is obtained for each feature. The respective chart 200, 202 is generated by checking, based on the respective data tree, the estimate for a respective starting value of that respective data tree for each input value of the chart.

Ultimately, a chart is preferably obtained for the feat₁ to featₙ features, so that the underlying data trees from the training are not needed further. Preferably, each chart or underlying data tree was trained in parallel. The resulting model or machine-learning algorithm 100, as the case may be, includes the n charts for each of the n features.

Based on a generalized additive model, GAM, algorithm, a feature function for each feature may now be replaced and/or supplemented with a chart as previously generated. Since these are modified functions, they are designated with the index p instead of the index m compared to equation 1. The index p preferably corresponds to the previously used index n.

g(E[y])=β₀+f₁(x₁)+f₂(x₂)+ . . . +fₚ(xₚ) {equation 2}

The charts can thus be incorporated into the respective feature-related function determination, as shown schematically in FIG. 2 by representation of equation 2.

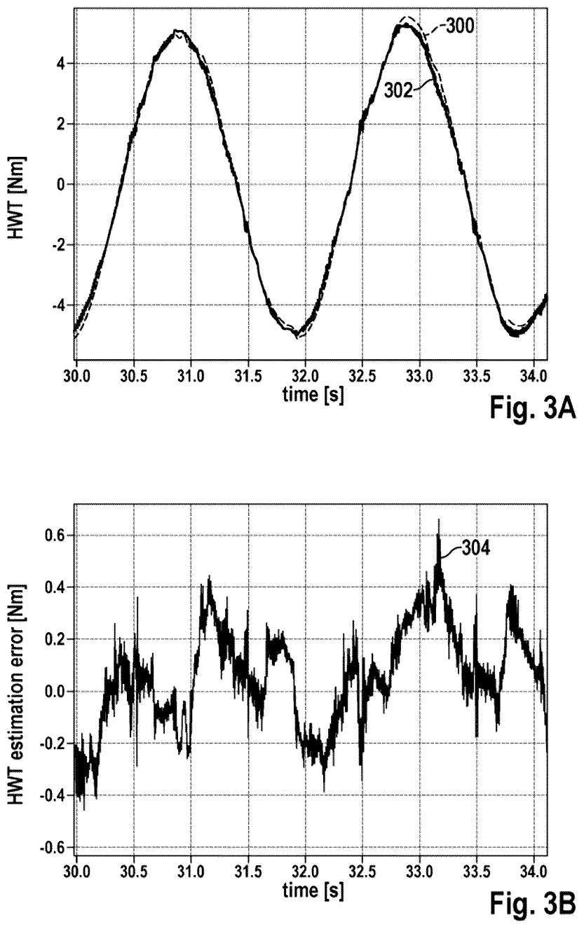

FIG. 3Aa is a schematic diagram comparing a measured steering torque 300 and an estimated steering torque according to the invention 302. The time t [s] is plotted on the ordinate. The torque HWT is plotted on the abscissa in [Nm]. It can be clearly seen that a curve of the estimated steering torque 302 corresponds almost congruently to a curve of the measured steering torque 300. Thus, the estimation of the steering torque 302 according to the present invention is nearly equivalent to the measured steering torque 300.

In FIG. 3B, a schematic diagram of a time course of a torque error 304 of the steering torque 302 estimated according to the present invention is shown. The time t [s] is plotted on the ordinate. On the abscissa, the HWT torque error in [Nm] is plotted. It can be seen that only a low torque error 304 occurs due to the estimation of the steering torque 302 according to the invention, i.e. the steering torque can be estimated quite accurately. This plausibly shows that, in principle, use of a torsion rod sensor may be dispensed with since the steering torque 302 may be estimated with sufficient accuracy.

1. A computer-implemented method for estimating a steering torque in a steering system of a vehicle and/or a machine, the method comprising
providing a machine-learning algorithm;
providing at least one input signal comprising information about at least one movement variable of the electric motor of a control element of the steering system; and
estimating, with the machine-learning algorithm, the steering torque applied by an operator via the control element based on the at least one input signal provided.

2. The method according to claim 1, wherein the machine-learning algorithm comprises an explainable boosting machine, EBM, algorithm, and/or a generalized additive model, GAM, algorithm, and/or a regression-based algorithm.

3. The method according to claim 2, wherein a fit function to a plurality of data points is determined by the GAM algorithm based on a plurality of cumulative spline functions using at least one regularization term.

4. The method according to claim 2, wherein the EBM algorithm is built on a GAM algorithm and is expanded with a data tree-based approach.

5. The method according to claim 1, wherein the machine-learning algorithm is trained on the basis of training data via the at least one input signal of the electric motor of the control element of the steering system.

6. The method according to claim 1, wherein the at least one input signal comprises rotor position information and/or rotor speed information and/or rotor acceleration information and/or rotor jerking information and/or motor target torque information and/or information about a gradient of the motor target torque and/or motor actual torque information and/or information about a gradient of the motor actual torque.

7. The method according to claim 1, wherein the at least one input signal is filtered by applying a moving average and/or a low-pass filter.

8. The method according to claim 1, wherein the control element comprises a steering wheel and/or a joystick and/or a steering lever and/or a steering switch.

9. A controller of a steering system and/or a vehicle comprising at least one processor and/or an analysis and control device configured to at least partially perform the method of claim 1.

10. A device for estimating a steering torque in a steering system of a vehicle and/or a machine, the device comprising:
a supply unit that is configured to provide a machine-learning algorithm and at least one input signal comprising information about at least one movement variable of an electric motor of a control element of the steering system; and
an analysis and computing device configured to estimate and/or approximate the steering torque applied by an operator by way of the control element by using the machine-learning algorithm based on the at least one input signal provided.

11. A steering system of a vehicle and/or machine comprising a control element configured to apply steering torque by an operator, an electric motor coupled to the control element, and a device according to claim 10.

12. A computer program comprising program code to execute at least portions of a method according to claim 1 if the computer program is executed on a computer.

13. A computer-readable data carrier comprising program code of a computer program to execute at least portions of a method according to claim 1 if the computer program is executed on a computer.

14. A steering system of a vehicle and/or machine comprising a control element configured to apply steering torque by an operator, an electric motor coupled to the control element, and a controller according to claim 9.
